(19) United States
(12) Patent Application Publication
(10) Pub. No.: US 2011/0007388 A1
(43) Pub. Date: Jan. 13, 2011

(54) Vehicles Having a High Efficiency Solar Control System

(76) Inventors: Stephen S. Wilson, Las Vegas, NV (US); Bart Wilson, Las Vegas, NV (US); Seth Wilson, Las Vegas, NV (US)

Correspondence Address: STETINA BRUNDA GARRED & BRUCKER, 75 ENTERPRISE, SUITE 250, ALISO VIEJO, CA, 92656, US

(21) Appl. No.: 12/501,327

(22) Filed: Jul. 10, 2009

(51) Int. Cl. G02B 5/26; B60J 11/08

(52) U.S. Cl. 359/360

(57) ABSTRACT

An automobile or vehicle having a high efficiency solar control system is provided. The automobile may have a window defined by a sheet of glass and a film mounted to its exterior side. The film may reflect solar radiation in the near and mid infrared ranges yet allow high transmission of light in the visible range such that the occupants of the automobile may view his/her surroundings through the window. The film may have a layer of silver which reflects the solar radiation in the near and mid infrared ranges. Since the silver is susceptible to oxidation and turns the silver into a black body which absorbs the near and mid infrared radiation, the film may be designed to slow the rate of oxidation of the silver layer to an acceptable level. The silver layer may be sandwiched between the glass which does not allow oxygen to diffuse there through and reach the layer of silver and a stack of sacrificial layers having a certain thickness which slows down the rate of oxygen diffusion to an acceptable level.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to an automobile having a film mounted to its window for reducing solar radiation load.

In warm and humid climates, direct sunlight on an automobile or vehicle, and more particularly to a cabin of the automobile may cause drivers to use the air conditioning system and/or use the air conditioning system at a higher level. Unfortunately, the air conditioning system may consume a large percentage of energy expended by the automobile in light of its overall energy consumption. By way of example and not limitation, the air conditioning system of the automobile may consume approximately twenty percent (20%) to about sixty percent (60%) of the total amount of energy consumed by the automobile. As such, reducing the cooling needs may reduce total energy consumption by the automobile.

A few factors determine the comfort level within the cabin of the automobile. They include the cabin air temperature, air speed within the automobile cabin, humidity of the air within the automobile cabin and the amount of thermal radiation entering the automobile cabin. When the cabin air temperature is uncomfortably hot, the automobile occupants may turn on the air conditioning system to cool down the average air temperature. In this instance, the air conditioning unit consumes energy to reduce the air temperature of the automobile cabin. The automobile occupants may also turn on and/or increase fan speed to increase air speed of the air circulating within the automobile cabin. The fan consumes energy. The speed of air within the automobile cabin increases evaporation of moisture on the skin of the automobile occupants which cools the occupant's skin temperature.

While driving during the day, the automobile cabin is exposed to the solar radiation. A portion of the solar radiation is absorbed by the window of the automobile cabin and heated. For example, a large portion of the near infrared radiation and all of the mid infrared radiation are absorbed by the window and re-radiated into the interior of the automobile cabin. The heated window re-radiates heat into the automobile cabin to thereby increase the cabin's air temperature and heats up the interior of the cabin. A portion of the solar radiation is transmitted through the window and absorbed by the interior of the automobile cabin (e.g., dashboard, upholstery, etc.). Upon absorption, the interior of the cabin re-radiates the absorbed energy into the air within the automobile cabin. This further increases the air temperature within the automobile cabin. The hot air and the hot interior of the cabin re-radiates energy generally as infrared radiation in the mid infrared range. Unfortunately, automotive glass windows generally do not allow the mid infrared radiation to pass therethrough. As such, the mid infrared radiation is retained within the cabin and increases a temperature of the cabin above ambient temperature.

A portion of the solar radiation transmitted through the window may also be absorbed by the occupant's skin. This portion of the sun's rays may cause the occupants to feel uncomfortably hot thereby encouraging use of the air conditioning system of the automobile even if the cabin air temperature is within a comfortable range. This may cause the occupant to turn on the air conditioning system and/or fan. Use of the air conditioning system and the fan both consume energy. Any reduction in the use of the air conditioning system and fan would also reduce the total amount of energy consumed by the automobile.

The human skin contains receptors that are sensitive to thermal radiation in the infrared range. When the automobile occupants are exposed to infrared radiation, the occupants may be uncomfortable even if the cabin air temperature is within a comfortable range. The occupants may resort to decreasing the average air temperature of the cabin and increasing the air speed of the fan system to counteract the discomfort caused by thermal radiation, both of which consume increasing amounts of energy.

As such, there is a need in the art for an apparatus and method for reducing the need to use the air conditioning system and/or fan of the automobile and reducing occupant exposure to solar infrared radiation.

### BRIEF SUMMARY

The present invention addresses the needs discussed above, discussed below and those that are known in the art.

A vehicle is provided having a high efficiency solar control system. The solar control system may comprise a glass sheet and a film mounted to its exterior side, namely, the side closer to the environment. The glass and film may define a window (e.g., side window, windshield, rear window or windshield, etc.) of the vehicle or automobile. The film may have high transmission of light in the visible range such that the occupants of the vehicle may view his/her surroundings through the window. Also, the film may reflect a high percentage of light in the near infrared range and the mid infrared range back into the environment. As such, the solar load on the cabin of the automobile is reduced by the amount of solar radiation in the near infrared range and the mid infrared range reflected back into the environment.

The film may additionally have a plurality of sacrificial layers which have a high transmission value with respect to the visible range and the near and mid infrared ranges. The topmost sacrificial layer may be removed or peeled away when it has been unacceptably degraded due to environmental elements (e.g., chips, oxidation, etc.) thereby exposing a fresh new topmost layer. Additionally, the additional sacrificial layers mitigate oxidation of a silver layer embedded within the film. In particular, the film is mounted to glass. As such, one side of the film does not allow diffusion of oxygen into the film since oxygen cannot diffuse through the glass. On the other side of the film (or the silver layer(s)), a thick stack of sacrificial layers may be formed. Although oxygen may be diffused through the sacrificial layers, such diffusion of oxygen through the sacrificial layers may be slowed down by increasing the thickness of the sacrificial layers. Either or both the number of sacrificial layers may be increased or decreased as appropriate or the thickness of each of the sacrificial layers may be increased or decreased to bring the rate of oxygen diffusion to an acceptable level. The silver layer is disposed between the glass and the thick stack of sacrificial layers which protects the silver layer from oxidation.

More particularly, an automobile having a cabin is disclosed. The automobile may comprise an automotive glass window and a film. The automotive glass window may define an interior side and an exterior side. The interior side defines an automotive cabin. The film may be attached to the exterior side of the glass window for reflecting infrared radiation away from the glass window.

The film may comprise an infrared reflecting layer defining an interior side and an exterior side. The interior side of the infrared reflecting layer may be attached to the exterior side of the glass window. The infrared reflecting layer may have an embedded infrared reflecting core which comprises one or more layers of silver and one or more layers of dielectric for reflecting infrared radiation. The silver layers and dielectric layers may alternate. One or more protective layers may be removeably attached to the exterior side of the infrared reflecting layer for mitigating oxidation of the silver layer and for providing a sacrificial top layer which can be removed when damaged the top layer is due to ultraviolet light exposure and/or oxidation.

An adhesive layer may be disposed between the infrared reflecting film and the automotive glass window for adhering the infrared reflecting film to the automotive glass window. The adhesive layer may cover most if not all of the infrared reflecting film. The protective layer may be generally transparent to visible wavelengths of light. The protective layer may be fabricated from a biaxially-oriented polyethelene terephthalate material. The protective layers are peelably adhered to one another. The adhesive used to adhere the protective layers to each other may be an ultraviolet light absorbing adhesive. Such adhesive may cover most if not all of the protective layer. An exterior side of each of the protective layers may have an ultraviolet light absorbing hard coat.

A method for reducing an amount of heat within a cabin of an automobile wherein the heat is caused by solar infrared radiation is also disclosed. The method may comprise the steps of providing a film for reflecting infrared radiation and attaching an interior side of the infrared reflecting layer to an exterior side of an automotive glass window. In the providing step, the film may comprise an infrared reflecting layer defining an interior side and an exterior side. The infrared reflecting layer may have an embedded infrared reflecting core which comprises one or more layers of silver and one or more layers of dielectric for reflecting solar infrared radiation. The film may also comprise one or more protective layers removeably attached to the exterior side of the infrared reflecting layer for mitigating oxidation of the silver layer and for providing a sacrificial top layer which can be removed when damaged due to ultraviolet light exposure and/or oxidation.

The attaching step may further comprise the step of adhering the interior side of the infrared reflecting layer to the exterior side of the automotive glass window.

Additionally, a second embodiment of the automobile having a high efficiency solar control system is disclosed. The automobile may have a cabin and comprise an automotive glass window defining an interior side and an exterior side. The interior side of the window defines the automotive cabin. The automobile may define a film attached to the exterior side of the glass window for reflecting infrared radiation away from the glass window.

The film may comprise an infrared reflecting core which comprises one or more layers of silver and one or more layers of dielectric for reflecting infrared radiation. The infrared reflecting core may define opposed first and second sides. The film may further comprise a first protective layer attached to the first side of the infrared reflecting layer and a second protective layer. The first protective layer may define a first thickness. The second protective layer may be attached to the second side of the infrared reflecting layer and the automotive glass window. The second protective layer may define a second thickness wherein the first thickness is greater than the second thickness. The first and second protective layers provide structural support to the one or more silver layers. The thicker first protective layer mitigates oxidation of the one or more silver layers caused by oxygen diffusion through the first protective layer.

The film may further comprise a stack of protective layers removeably attached to each other such that a top most protective layer may be removed and discarded when the top most protective layer is damaged due to ultraviolet light exposure. The stack of protective layers may be adhered to each other.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates an automobile having a high efficiency solar control system;

FIG. 2 is a cross-sectional view of a window of the automobile shown in FIG. 1;

FIG. 2A is a cross sectional view of a prior art automotive window without an absorption film;

FIG. 2B is a cross sectional view of the prior art automotive window with an absorption film;

FIG. 3 is an enlarged view of the window shown in FIG. 2; and

FIG. 4 illustrates an alternate embodiment of the film shown in FIG. 3.

### DETAILED DESCRIPTION

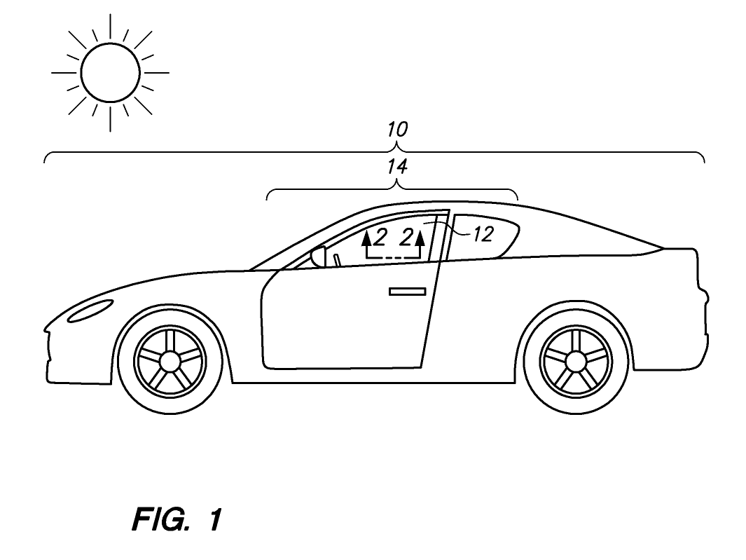

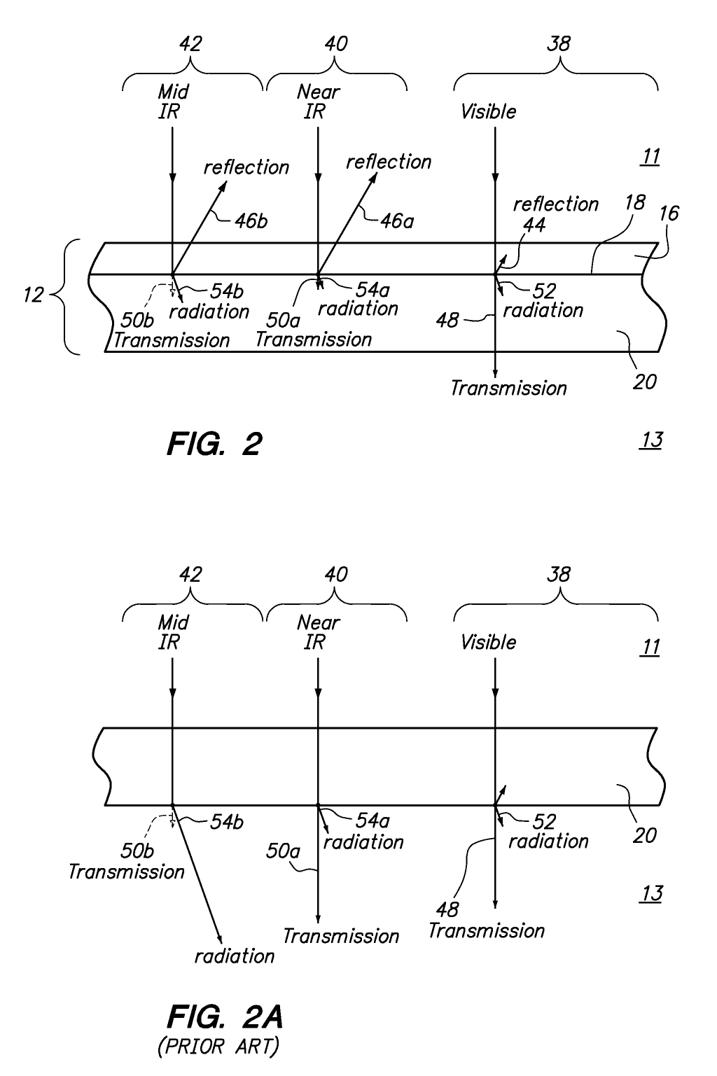

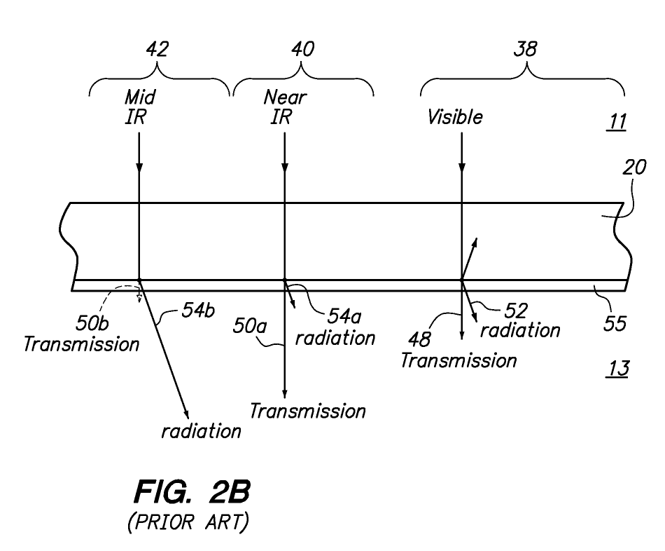

Referring now to FIG. 1, an automobile 10 having a window 12 is shown. The window 12 protects the occupants from environmental elements (e.g., wind, rain, etc.) yet allows the occupants to view the surroundings from within a cabin 14 of the automobile 10. As shown in FIG. 2, the window 12 may have a film 16 attached to an exterior side 18 of a glass 20. The film 16 may be generally optically transparent in the visible wavelengths and generally reflect radiation in the non-visible or infrared wavelengths. The sun's rays transmit solar radiation both in the visible light range and also in the infrared range. A majority of the radiation in the infrared range may be reflected back to the exterior 11 of the cabin 14 by the film 16. A small portion of the energy may be transmitted into the cabin 14 through the glass 20 and a small portion is absorbed by the glass 20, converted into heat and re-radiated into the interior 13 of the cabin 14. Beneficially, the film 16 reduces the amount of solar radiation in the near and mid infrared ranges from entering into the cabin 14 by reflecting a large percentage back to the environment. As such, the amount of solar radiation introduced into the air of the cabin 14, absorbed into the interior of the cabin 14 and contacting the occupant's skin is reduced. This lowers the average air temperature within the cabin 14. This also reduces discomfort of the occupants due to exposure to infrared radiation when the occupant is in the line of sight of the sun. Beneficially, the film 16 increases the automobile occupant's comfort with respect to temperature.

As shown in FIG. 2, solar radiation may be divided into the visible range 38, near infrared range 40, and the mid-infrared range 42. For each of these ranges 38, 40, 42, a portion of the solar radiation is transmitted through the film 16 and a portion of the solar radiation is reflected back to the exterior 11 of the cabin 14 as shown by arrows 44, 46a, b. In the visible range 38, a large percentage (i.e., more than 50%, but preferably about 70% or more) of the light is transmitted through the film 16. In contrast, in the near infrared range 40 or the mid infrared range 42, a large percentage (i.e., more than 50% but preferably about 80% or more) of the light is reflected back to the exterior 11 of the cabin 14. Since the film 16 is mounted to the exterior of the glass 20, less of the near infrared radiation 40 and the mid infrared radiation 42 reaches the glass 20 compared to the prior art as shown by comparing FIG. 2 with FIGS. 2A and 2B. FIG. 2A illustrates untreated automotive glass 20. FIG. 2B illustrates automotive glass 20 with a commonly used absorption film 55 mounted to the interior or inside of the glass 20. The lengths of the lines 54a, b and 50 which generally indicates magnitude of transmission and radiation is longer in FIGS. 2A and 2B compared to FIG. 2. As shown, the glass 20 is heated to a lesser extent and the amount of near IR radiation 40 transmitted through the glass 20 is less with use of the film 16 mounted to the exterior of the glass 20 such that the heat load on the cabin 14 and occupant exposure to near infrared radiation 40 is reduced. This promotes less or no use of the air conditioning system and/or fan of the automobile 10.

For that portion of the solar radiation transmitted through the film 16, a portion is transmitted through the glass 20 as shown by arrows 48 and 50a. The remainder is absorbed into the glass 20 thereby heating the glass 20 and re-radiating that energy into the interior 13 of the cabin 14 as shown by arrows 52, 54a, b. Generally for automotive glass, all of mid infrared radiation 42 is absorbed by the automotive glass 20 and reradiated into the interior 13 of the automotive cabin 14 as shown by arrow 54b. However, it is contemplated that other glass compositions may be employed for automobiles such that a portion of the mid infrared radiation 42 may be transmitted through the glass 20 as shown by the dash line 50b. The film 16 has a high percentage (i.e., more than 50% but preferably about 70% or more) of transmission 48 of the solar radiation in the visible range 38 and a high percentage (i.e., more than 50% but preferably 80% or more) of reflection 46a, b in the near-infrared range 40 and the mid-infrared range 42. The film 16 also reflects a portion of the solar radiation in the far infrared range (not shown in FIG. 2).

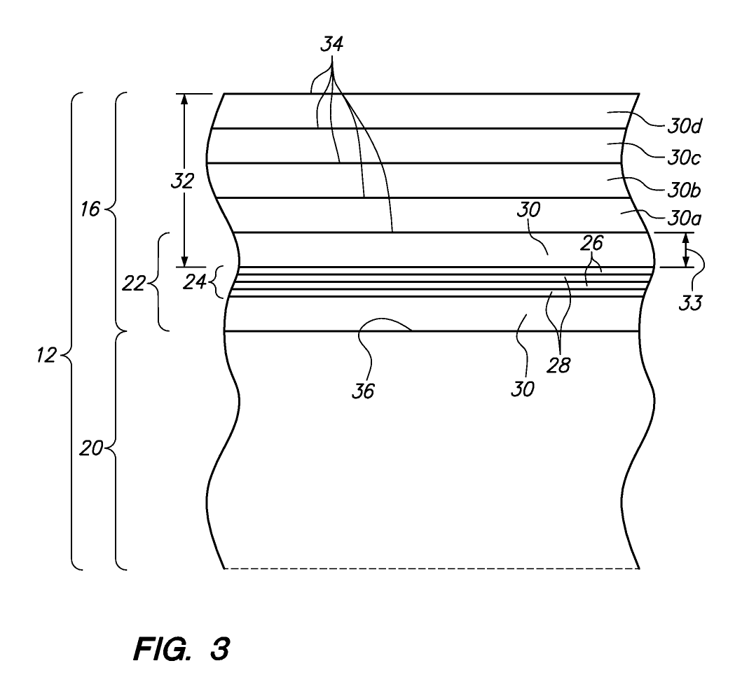

Referring now to FIG. 3, an enlarged cross-sectional view of film 16 and glass 20 is shown. The film 16 may have an infrared reflecting layer 22 with an embedded infrared reflecting core 24. The infrared reflecting core 24 may comprise one or more silver layers 26 and one or more dielectric layers 28. The silver layer 26 and the dielectric layer 28 may alternate such that the infrared reflecting core 24 may comprise a layer of dielectric 28, a layer of silver 26, a layer of dielectric 28, a layer of silver 26, a layer of dielectric 28 all stacked upon each other. Preferably, the dielectric layers 28 are the outermost layers of the embedded infrared reflecting core 24. At a minimum, one silver layer 26 is disposed between two layers of dielectric 28. The silver layers 26 and dielectric layers 28 may have a thickness measured in nanometers. The silver layer 26 may be generally transparent in the visible range and reflect a high percentage of infrared radiation especially in the near infrared range 40 and the mid infrared range 42. The number and thickness of silver layers 26 and the number and thickness of dielectric layers 28 may be adjusted to tune the amount or percentage of infrared radiation being reflected by the infrared reflecting core 24.

The infrared reflecting core 24 may be sandwiched between two layers 30 of material having high transmission (i.e., greater than 50% but preferably about 90% or more) both in the visible range and the near and mid infrared ranges. By way of example and not limitation, the layer 30 may be biaxially-oriented polyethelene terephthalate (hereinafter “BoPET”) mylar. BoPET is the preferred material since it is dimensionally stable (i.e., not elastic), has a high transmission in the visible and near and mid infrared ranges, low scatter and low cost. The dimensionally stability of the BoPET layer 30 provides support for the silver layer 26. Otherwise, the silver layer 26 may crack or become damaged upon stretching of the layer 30. Additionally, the BoPET layer 30 does not behave as a black body or absorb a low percentage (i.e., less than 30%) of solar radiation both in the visible range 38 as well as in the near and mid infrared ranges 40, 42. Accordingly, the infrared reflecting layer 22 is useful for reflecting solar thermal radiation in the near and mid infrared ranges 40, 42 and allowing light in the visible range 38 to be transmitted through the BoPET layers 30 and the infrared reflecting core 24.

One of the characteristics of the silver layer 26 is that upon exposure to oxygen, the silver oxidizes as a black material. In the oxidation process, the silver is converted from a material that reflects heat in the near to mid infrared ranges 40, 42 to a black body that absorbs heat in the near to mid infrared ranges 40, 42. Instead of reflecting a majority of the heat in the near and mid infrared ranges 40, 42, the silver layer 26 now absorbs radiation in both the visible range 38 and the near and mid infrared ranges 40, 42. Detrimentally, the silver layer 26 absorbs and re-radiates such energy into the cabin 14. Additionally, one of the characteristics of the BoPET layer 30 is that oxygen diffuses through the BoPET layer 30 such that oxygen ultimately reaches the silver layer 26 and oxidizes the same 26. To prevent or reduce the rate of oxidation of the silver layers 26 to an acceptable rate, additional layers 30a-d may be stacked on the infrared reflecting layer 22. Any number of layers 30a-n may be stacked on the infrared reflecting layer 22. The amount of oxygen diffused through the layers 30a-n and 30 is a function of a distance 32 from the silver layer 26 and the exterior side 34 of the topmost layer 30. The amount of oxygen reaching the silver layer 26 from an exterior side (i.e., from outside the automobile 10) is reduced since the oxygen must travel a greater distance through the layers 30a-n and 30. On the interior side, the film 16 is mounted to the glass 20 which protects the silver layer(s) 26 from oxidation. Oxygen does not pass through the glass 20.

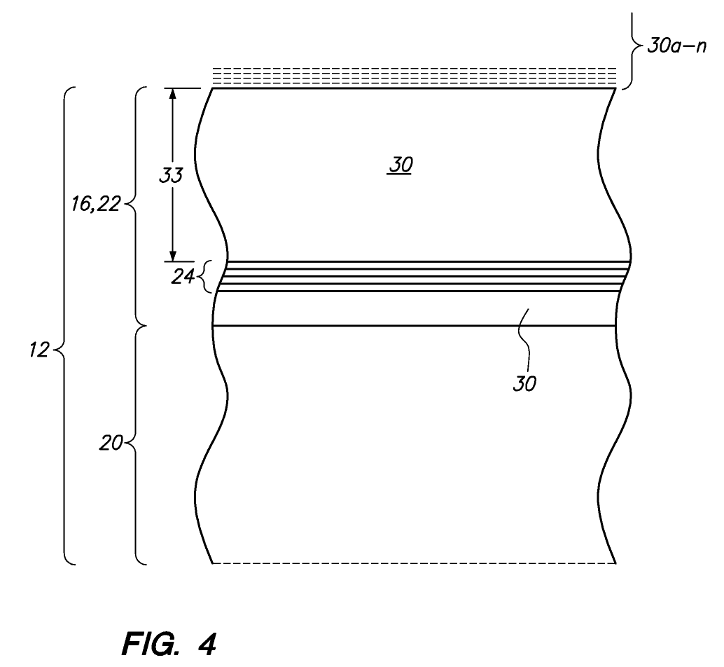

Alternatively, it is contemplated that the thickness 33 of the BoPET layer 30 in the infrared reflecting layer 22 may be increased (see FIG. 4) to slow down the rate of oxidation of the silver layers 26 to an acceptable level. Additionally, an additional stack of BoPET layers 30a-n may be adhered to the BoPET layer 30 on the exterior side, as shown in FIG. 4. The stack of BoPET layers 30a-n may be removably adhered to each other such that the topmost BoPET layer 30a-n may be used as a sacrificial top layer as discussed herein.

Referring back to FIG. 3, during use, the exterior side 34 of the topmost layer 30d is exposed to environmental elements such as rain (containing chemicals), rocks, dirt, ultraviolet light, etc. As such, the exterior side 34 of the topmost layer 30d may experience physical degradation (e.g., chips, oxidation, etc.). It may be difficult to see through the film 16 due to the degradation of the topmost layer 30d. Beneficially, each of the layers 30a-d may be removed (e.g., peeled away) from each other and also from the infrared reflecting layer 22. The then topmost layer behaves as a sacrificial layer which is removed when it has been unacceptably degraded by the environmental elements. To this end, the layer 30d may be peelably adhered to layer 30c, layer 30c may be peelably adhered to layer 30d, layer 30d may be peelably adhered to layer 30a and layer 30a may be peelably adhered to the infrared reflecting layer 22. A tab or other means of removing the topmost layer 30d may be provided such that the topmost layer 30d may be peeled off of the adjacent lower layer 30c when the topmost layer 30d is unacceptably degraded. Upon further use, the new top layer 30c experiences physical degradation. When the then topmost layer 30c is degraded to an unacceptable level, the topmost layer 30c is now peeled away from the top layer 30b. The process is repeated for layers 30b and 30a. As the topmost layers 30d, c, b, a are peeled away, the rate of oxidation of the silver layer 26 increases. As such, the number of layers 30a-n may be increased or decreased based on the required useful life of the film 16. To extend the useful life of the film 16, additional layers 30a-n are stacked upon each other to increase the distance 32. Conversely, to decrease the useful life of the film 16, fewer layers 30a-n are stacked upon each other to decrease the distance 32. When the silver layer 26 is unacceptably oxidized, the entire film 16 is removed from the glass 20 and a new film 16 is mounted to the exterior surface 36 of the glass 20.

Each of the BoPET layers 30a-d and 30 may define an exterior side 34. An ultraviolet light absorbing hard coat may be coated onto the exterior side 34 of the BoPET layers 30a-d and 30 to slow the damaging effects of ultraviolet light on the BoPET layer 30. Additionally, the adhesive for attaching the BoPET layers 30a-d to each other as well as the adhesive for adhering the BoPET layer 30a to the infrared reflecting layer 22 may be an ultraviolet light absorbing adhesive to further slow the damage of ultraviolet light exposure. Such adhesives may continuously cover most if not all of the BoPET layer 30a-d and the infrared reflecting layer 22.

A method for attaching the film 16 to the glass window 20 will now be described. Initially, the film 16 is provided. The film 16 may have a peelable protective layer on both sides to protect the silver layers 26 from oxidation and the exterior surfaces from oxidation as well as chipping prior to installation and during storage. The protective layer may be impermeable to oxygen to prevent oxidation of the exterior surfaces of the film 16 as well as oxidation of the silver layers 26. The protective layer may also block ultraviolet light to mitigate damage to the film 16 in the event the film 16 is left out in the sun. The protective layer may be adhered to the exterior surfaces of the film 16 in a peelable fashion. Prior to mounting the film 16 to the glass 20, the film 16 may be cut to the size of the automobile window. After the film 16 is cut to size, the protective layers may be peeled away to expose the film 16. The exposed side of the infrared reflecting layer 22 may have a pressure sensitive adhesive that may be activated by water or other fluid. The pressure sensitive adhesive may continuously cover most if not all of the exposed side of the infrared reflecting layer 22. The exterior side of the glass 20 may be wetted down with water or the other fluid. The cut film 16 may now be laid over the exterior side of the window 12. Any air bubbles may be squeegeed out. The moist adhesive on the infrared reflecting layer 22 is allowed to dry such that the film 16 is mounted to the glass 20 and the film 16 cannot slip with respect to the glass 20.

The film 16 may be fabricated in the following manner. Initially, a BoPET layer 30 is provided as a roll. The BoPET layer 30 is unrolled and a layer of dielectric 28 is formed on one side of the BoPET layer 30. The thickness of the BoPET layer 30 may be approximately two thousandths of an inch thick. The thickness of the dielectric layer 28 may be measured in nanometers. As the layer of dielectric 28 is laid on one side of the BoPET layer 30, the BoPET layer 30 is rerolled. The BoPET layer 30 is then unrolled such that a layer of silver 26 may then be laid on top of the layer of dielectric 28. The silver layer 26 is also measured in nanometers and is extremely thin. The BoPET layer 30 is rolled back up and unrolled a number of times until the desired number of silver and dielectric layers 26, 28 is attained. A second BoPET layer 30 (about 0.002 inches thick) may be laminated onto the dielectric layer 28 such that two BoPET layers 30 sandwich the alternating layers of silver 26 and dielectric 28 which form the infrared reflecting core 24. Thereafter, additional layers of BoPET 30a-n (each layer being about 0.002 inches thick) may be laminated onto the infrared reflecting layer 22 to serve as a sacrificial layer and reduce the rate of oxygen diffusion. Optionally, protective layers for protecting the film 16 during storage and prior to installation may be laminated onto opposed sides of the film 16. The thickness of the film 16 may be limited by the amount of bending required to roll the film 16 during manufacture. For thicker films 16, it is contemplated that the film 16 may be fabricated in a sheet form process.

The above description is given by way of example, and not limitation. Given the above disclosure, one skilled in the art could devise variations that are within the scope and spirit of the invention disclosed herein, including various ways of adhering the film 16 to the glass 20. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An automobile having a cabin, the automobile comprising:
an automotive glass window defining an interior side and an exterior side, the interior side defining the automotive cabin;
a film attached to the exterior side of the glass window for reflecting infrared radiation away from the glass window, the film comprising:
an infrared reflecting layer defining an interior side and an exterior side, the interior side of the infrared reflecting layer attached to the exterior side of the glass window, the infrared reflecting layer having an embedded infrared reflecting core which comprises one or more layers of silver and one or more layers of dielectric for reflecting infrared radiation;
one or more protective layers removeably attached to the exterior side of the infrared reflecting layer for mitigating oxidation of the silver layer and for providing a sacrificial top layer which can be removed when damaged the top layer is due to ultraviolet light exposure and/or oxidation.

2. The automobile of claim 1 further comprising an adhesive layer disposed between the infrared reflecting layer and the automotive glass window for adhering the film to the automotive glass window.

3. The automobile of claim 1 wherein the protective layer is generally transparent to visible wavelengths of light.

4. The automobile of claim 1 wherein the protective layer is biaxially-oriented polyethelene terephthalate.

5. The automobile of claim 1 wherein the silver and dielectric layers alternate.

6. The automobile of claim 1 wherein the protective layers are peelably adhered to one another.

7. The automobile of claim 1 wherein an exterior side of each of the protective layers has an ultraviolet light absorbing hard coat.

8. The automobile of claim 2 wherein the adhesive is an ultraviolet light absorbing adhesive.

9. The automobile of claim 1 wherein the one or more protective layers is sufficiently thick to reduce the rate of oxidation of the silver layer to a level such that the film has a sufficiently useful long life.

10. The automobile of claim 1 wherein the one or more protective layers is fabricated from biaxially-oriented polyethelene terephthalate

11. A method for reducing an amount of heat within a cabin of an automobile wherein the heat is caused by solar infrared radiation, the method comprising the steps of:
providing a film for reflecting infrared radiation, the film comprising:
an infrared reflecting layer defining an interior side and an exterior side, the infrared reflecting layer having an embedded infrared reflecting core which comprises one or more layers of silver and one or more layers of dielectric for reflecting solar infrared radiation; and
one or more protective layers removeably attached to the exterior side of the infrared reflecting layer for mitigating oxidation of the silver layer and for providing a sacrificial top layer which can be removed when damaged due to ultraviolet light exposure and/or oxidation; and
attaching an interior side of the infrared reflecting layer to an exterior side of an automotive glass window.

12. The method of claim 11 wherein the attaching step comprising the step of adhering the interior side of the infrared reflecting layer to the exterior side of the automotive glass window.

13. An automobile having a cabin, the automobile comprising:
an automotive glass window defining an interior side and an exterior side, the interior side defining the automotive cabin;
a film attached to the exterior side of the glass window for reflecting infrared radiation away from the glass window, the film comprising:
infrared reflecting core which comprises one or more layers of silver and one or more layers of dielectric for reflecting infrared radiation, the infrared reflecting core defining opposed first and second sides;
a first protective layers attached to the first side of the infrared reflecting layer, the first protective layer having a first thickness;
a second protective layer attached to the second side of the infrared reflecting layer and the automotive glass window, the second protective layer having a second thickness, the first thickness being greater than the second thickness;
wherein the first and second protective layers provide structural support to the one or more silver layers, and the thicker first protective layer mitigates oxidation of the one or more silver layers caused by oxygen diffusion through the first protective layer.

14. The automobile of claim 13 further comprising a stack of sacrificial layers removeably attached to each other such that a top most protective layer may be removed and discarded when the top most protective layer is damaged due to ultraviolet light exposure or oxidation.

15. The automobile of claim 14 wherein the sacrificial layers are adhered to each other.

16. The automobile of claim 13 wherein the first thickness is sufficiently thick to reduce the rate of oxidation of the silver layer to a level such that the film has a sufficiently long useful life.
